(19) United States
(12) Patent Application Publication
(10) Pub. No.: US 2019/0347738 A1
(43) Pub. Date: Nov. 14, 2019

(54) SYSTEM AND METHOD FOR REDUCING FRAUD IN TRADE INSURANCE AND FINANCING

(71) Applicant: VESL PTE. LTD., Singapore (SG)

(72) Inventors: Maureen Nova Chua LEDESMA, Bacolod City (PH); Jessica Jardeleza MANIPON, Quezon City (PH); Yroen Guaya MELGAR, Iloilo City (PH); Christian CALABIA, Pasig City (PH)

(73) Assignee: VESL PTE. LTD., Singapore (SG)

(21) Appl. No.: 16/466,632

(22) PCT Filed: Dec. 6, 2017
(86) PCT No.: PCT/SG2017/050601

§ 371 Date: Jun. 4, 2019

(30) Foreign Application Priority Data
Dec. 6, 2016 (US) 62430396

(51) Int. Cl. G06Q 40/08; G06Q 30/00

(52) U.S. Cl. CPC G06Q 40/08; G06Q 30/0185

(57) ABSTRACT

The invention relates to a system and method for providing trade insurance and finance. The system comprises a central controller arranged in communication with one or more databases to electronically obtain information from the databases, wherein the information includes an invoice, and a blockchain hub operationally connected to the central controller for circulating the information from the central controller to one or more platforms. The blockchain hub, which bills of lading are also encoded and verified, is capable of generating a hash response output based on a request from the one or more platforms, and wherein if the invoice meets at least one pre-determined criterion, the central controller provides the invoice to an insurer for insurance and a lender for financing the invoice.

### FIELD OF INVENTION

The invention relates to a system and method for reducing fraud in particular in trade finance transactions and specifically relates to trade credit insurance.

### BACKGROUND

The following discussion of the background to the invention is intended to facilitate an understanding of the present invention. However, it should be appreciated that the discussion is not an acknowledgment or admission that any of the material referred to was published, known or part of the common general knowledge in any jurisdiction as at the priority date of the application.

In computerised transactions, a seller often sends goods to a buyer before getting paid for such goods. The seller might wait for a significant period of time before receiving payment for the goods. For instance, the seller might have to wait for 30 days, 60 days, 90 days, 120 days, etc., depending on terms of the transaction. In the meantime, the seller may have significant capital locked up in the goods. For example, the seller may have had to spend $1 million for the raw materials and labour to produce the goods. Until the seller receives payment, this capital is tied up and cannot be used for other operations, such as producing new goods. Accordingly, a seller is often interested in receiving at least some portion of the funds due to the seller prior to the anticipated or agreed date of payment.

A seller who is expecting payment on a transaction has a “trade receivable” (also known as “accounts receivable”). The trade receivable has value, especially if the buyer is creditworthy. Accordingly, a seller may seek a loan or other funding using the trade receivable as collateral. Receiving such a loan may be referred to as receiving “trade financing”, or similar such terminology. The seller can use proceeds from the trade financing as “working capital” to sustain ongoing operations and/or production. The lender, in turn, earns interest on the loan and minimises its risk. If the seller later defaults on the loan, the lender can recover all or a portion of the loan amount when the buyer finally pays for the goods.

One risk to a seller, and potentially to a lender, is that the buyer does not pay. For example, the buyer may become insolvent before payment is due. In this case, the seller may suffer the loss of capital invested in the goods. If the seller has taken a loan using the receivable as collateral, then the value of the collateral may be reduced or destroyed, and the lender may be unable to recover its loan.

Accordingly, a seller may seek insurance against the creditworthiness of the buyer. The “trade credit insurer” may pay out if the buyer becomes insolvent, is unable to pay its debts, and/or is unable to pay the seller and/or otherwise fails to pay the seller.

Another risk to a seller, and potentially to a lender, is that the goods do not reach the buyer intact. For example, the goods may be lost, stolen, damaged, etc. In this case, the buyer may refuse to pay and the seller will suffer the loss of capital invested in the goods. If the seller has taken a loan using the receivable as collateral, then the value of the collateral may be reduced or destroyed, and the lender may be unable to recover its loan.

Accordingly, a seller may seek insurance against loss, theft, or damage of the sold goods. This insurance may allow the seller to receive compensation for the sold goods even if they are lost, stolen, etc.

By some estimates, demand for trade financing is high. However, many sellers desiring trade financing are unable to obtain it. By some estimates, in 2015, nearly $1.4 trillion worth of trade financing was desired but not obtainable. Many sellers that were unable to obtain desired financing were small and medium-sized enterprises (“SMEs”). This “trade financing gap” creates a hardship for sellers, and potentially lost productivity through lack of access to working capital. Further, the trade financing gap presents a lost opportunity for lenders to earn significant revenue in the form of interest.

One possible reason that many sellers do not receive trade financing is a fear by lenders that the seller will commit fraud. This fear may be magnified when a seller is relatively small or unknown. A seller may commit fraud by seeking trade financing more than once for the same sale. The seller may default on its loans, and then multiple lenders find that they are seeking to recover payment using the same collateral, which is insufficient. Of course, sellers may commit fraud in various other ways as well.

Another possible reason that many sellers, particularly the small and medium enterprises or SMEs, cannot access trade financing is that lenders either charge high interest rates or are unwilling to lend, sometimes at lower interest rates, without a protection of trade credit insurance. Trade credit insurance is usually very expensive, and the premium is based on the seller's yearly turnover. Moreover, trade credit insurance providers are unwilling to cover sellers with small turnover as the cost of covering small sellers is too high relative to the earnings.

Accordingly, there is a need to increase access to trade financing by reducing the possibility of fraud among sellers and making the provision of trade credit insurance more efficient, secure, and less costly for both providers and sellers.

### SUMMARY OF THE INVENTION

Various embodiments include systems and methods for facilitating the acquisition of trade financing and insurance using blockchain/distributed ledger technology.

Most lenders require some form of security to finance invoices. This security can come in the form of trade credit insurance. However, trade credit insurance premium rates are usually too expensive for smaller firms, and insurers typically don't cater to these smaller firms because of high administrative costs involved. The invention therefore allows small businesses access to invoice financing through trade credit insurance.

According to an aspect of the invention, there is a system for facilitating trade insurance and financing comprising, a central controller arranged in communication with one or more databases to electronically obtain information from the databases, wherein the information includes an invoice; and a blockchain hub operationally connected to the central controller for circulating the information from the central controller to one or more platforms, the blockchain hub capable of generating a hash response output based on a request from the one or more platforms, wherein if the invoice meets at least one pre-determined criterion, the central controller provides the invoice to an insurer for insurance and a lender for financing.

The invention provides a cost-effective, secure, and efficient way to connect businesses to both Insurers and Lenders.

Through the invention, different parties can interact to provide businesses with the requirements needed to secure and finance their transactions. Risks of fraud (eg. double invoice financing) is also mitigated as the platform makes use of blockchain/distributed ledger technology.

Preferably, one of the databases is a seller device in data communication with the central controller for sellers to submit invoices to the central controller.

It is an advantage if one of the databases is a buyer device in data communication with the central controller for buyers to engage with sellers who wishes to transact with them.

More advantageously, one of the databases is an insurer device in data communication with the central controller to receive the invoice transmitted by the central controller.

It is preferable if one of the databases is a verifier device in data communication with the central controller for verifying information transmitted to and from the central controller, including verifying whether the invoice meets various criteria and verifying authenticity of sales of goods.

It is also preferable if one of the databases is a lender device in data communication with the central controller for use by lenders to view information for making a decision on whether to finance invoices.

Advantageously the central controller comprises one or more components selected from a group including a processor, a memory, a communications port, an input device, an output device and a storage device.

Preferably each of the one or more databases contains information for identifying the database.

More preferably, one of more bills of lading are submitted to the central controller.

It is preferred if each bill of lading is encoded as a blockchain to be linked to one or more other bills of lading.

It is an advantage if verification of whether the invoice meets the predetermined criterion is carried out by matching the one or more bills of lading with a record in an external database.

Preferably successful verification results in approval of the invoice.

Preferably, the system is operable to work with one or more programmes selected from a group comprising: two factor authentication, optical character recognition, machine learning, database management, data analytics, business intelligence, artificial intelligence and application programming interface.

Preferably, the system includes a processor for processing insurance claims automatically upon non-payment of a buyer associated with the particular invoice.

Preferably, the blockchain hub comprises a distributed messaging system communicating with the one or more platforms for circulating the information from the central controller to the one or more platforms.

According to another aspect of the invention, there is a method for providing trade finance insurance, comprising the steps of storing information in one or more databases, wherein the information includes an invoice; and communicating the information to a central controller operationally connected to a blockchain hub generating a hash response output for circulation between one or more platforms; and

providing the invoice to a lender for financing the invoice if the invoice meets at least one pre-determined criterion.

Preferably information stored in the one or more databases is provided by one or more devices selected from a group comprising: a seller device, a buyer device, an insurer device, a verifier device and a lender device.

Optical character recognition is used for extracting information from the invoice.

Preferably the method further comprises the step of verifying the authenticity of a sale of goods related to the invoice.

It is preferred if the method further comprises the step of automatically processing an insurance claim upon non-payment of the invoice.

According to another aspect of the invention, there is a platform for facilitating procurement of insurance for trade finance, the platform comprising: a memory storing information about a seller and a buyer whom the seller wishes to trade with;

a processor for matching and tagging the seller to an insurer and/or to a specific lender; wherein transactions between the seller, the buyer, the insurer and the lender are recorded on a blockchain and/or distributed ledger.

Preferably the processer carries out the matching and tagging based on one or more pieces of information selected from a group comprising of location, industry, volume of turnover, average invoice value, pricing, payment terms.

The invention therefore is able to provide trade credit insurance per transaction in a single platform that also offers access to lending.

Trade finance and trade insurance remains generally paper-based which is inconvenient in today's digital economy. The computerised invention is distinguished from current platforms with its ability to integrate with various systems and interfaces of different parties to the transaction. This allows faster and more secure data transfer from one system to another. This includes integration to accounting platforms, insurance platforms, and lenders' systems.

By recording data from different users, patterns in user behaviour and transactions, the invention provides better insights on risk management, cash flow management, and even revenue generation. Credit risk, for instance, will not simply be based on macroeconomic, industry and financial risk, but will be able to take into account payment and risk avoidance patterns of parties to the transaction.

### BRIEF DESCRIPTION OF THE DRAWINGS

FIG. 1 depicts a system according to various embodiments.

FIG. 2 depicts a central controller according to various embodiments.

FIG. 3 depicts a seller device according to various embodiments.

FIG. 4 depicts a buyer device according to various embodiments.

FIG. 5 depicts an insurer device according to various embodiments.

FIG. 6 depicts a verifier device according to various embodiments.

FIG. 7 depicts a lender device according to various embodiments.

FIG. 8 depicts a seller database according to various embodiments.

FIG. 9 depicts a buyer database according to various embodiments.

FIG. 10 depicts a lender database according to various embodiments.

FIG. 11 depicts an insurer database according to various embodiments.

FIG. 12 depicts a verifier database according to various embodiments.

FIG. 13 depicts a log according to various embodiments.

FIG. 14 depicts a process performed by a seller according to various embodiments.

FIG. 15 depicts a process performed by an insurer according to various embodiments.

FIG. 16 depicts a process performed by a lender according to various embodiments.

FIG. 17 depicts a process performed by a verifier according to various embodiments.

FIG. 18 depicts the summary flow of the platform and its integration with compatible technologies.

FIG. 19 depicts the process flow of shared information.

FIG. 20 depicts the use Optical Character Recognition and Machine Learning.

FIG. 21 depicts the platform's integration with Blockchain/Distributed Ledger Technology.

FIG. 22 depicts Business Intelligence that may be generated with the platform.

FIG. 23 depicts the use of Two Factor Authentication (2FA).

FIG. 24 depicts matching of the seller-lender-insurer process.

### DETAILED DESCRIPTION

Various embodiments include systems and methods for facilitating the acquisition of trade insurance and trade financing. For instance, sellers may acquire trade financing for goods that they have sold but for which payment has not yet been received. Lenders, such as banks, may provide the trade financing. An insurer may provide credit insurance against default by the buyer. An insurer may also provide insurance against loss, theft, damages, etc., of goods, such as goods in transit. A verifier may verify that a purported sales transaction between the buyer and seller is authentic and/or legitimate. A log may maintain a record of transactions between buyers and sellers. The log may additionally or alternatively maintain a record of trade financing transactions. The log may thus reduce the possibility that the same transaction between buyer and seller is used more than once to obtain trade financing.

According to various embodiments, sellers may benefit from greater and/or more rapid access to trade financing. Sellers may thereby gain greater and/or more rapid access to working capital to finance ongoing operations, to maintain or increase productivity, etc.

According to various embodiments, lenders may benefit from an expanded pool of borrowers. Lenders may also benefit from risk mitigation for their loans. Some mitigation may come about as a result of credit insurance on buyers. For instance, even if a buyer becomes insolvent and a trade receivable (e.g., collateral) loses its value, the lender may still recover its loan from the credit insurance pay-out. Some mitigation may come about as a result of insurance against loss, theft, damages, etc. of the sold goods. Some mitigation may come as a result of a log or logs that reduce the likelihood of duplicate financing being provided to the seller for the same buy/sell transaction. Some mitigation may come as a result of a verification process that verifies the existence or authenticity of a buy/sell transaction.

### Log

In various embodiments, a log may provide a record of transactions. The log may include a record of one or more prior transactions. The log may include a record of all prior transactions that took place through the system.

The log may take various forms, according to various embodiments. The log may take the form of a paper file or files, a paper tape, a computer file, an electronic file, an electronic record, a database, a distributed database, a blockchain, a blockchain database, and/or any other form or combination of forms. In various embodiments, there may be multiple instances or copies of a log in existence. In various embodiments, a log may be stored in a single location. In various embodiments, a log may be stored in multiple locations, distributed, etc.

In various embodiments, the log may store information about a transaction. The information may include one or more of the following: (a) name or other identifier for a buyer; (b) name or other identifier for a seller; (c) name or other identifier for an insurer; (d) name or other identifier for a lender; (e) the goods being bought/sold (e.g., soy, rice, coffee, etc.); (f) the quantity of goods being bought sold (e.g., 1000 metric tonnes); (g) the port/location of shipment; (h) the port/location of delivery; (i) the date of shipment; (j) the date of delivery; (k) the nature, quality, and/or condition of goods upon shipping and/or upon delivery; (l) the terms of payment for goods bought/sold; (m) the amount to be paid for the goods; (n) the date when payment is due; (l) the amount of trade financing requested; (n) the amount of trade financing received; (o) terms for paying back the trade financing; (p) the carrier for the goods; (p) name or other identifier for a verifier; and/or any other information.

In various embodiments, information about a transaction may include information from a bill of lading. The bill of lading may include a list of goods being shipped as part of the transaction. Information stored in the log may include the bill of lading, a scanned copy of the bill of lading, information derived from the bill of lading (e.g., information derived via optical character recognition from the bill of lading), and/or any other information related to the bill of lading. The log may store some or all information from a bill of lading. The log may store any stamps, seals, or other approval associated with the bill of lading.

In various embodiments, the log is updated with a new transaction. For example, a new record, new database entry, new file, etc. may be added to the log when there is a new transaction. In various embodiments, an update to the log may include information about one or more prior transactions. In various embodiments, an update to the log may include information derived from one or more prior transactions. In various embodiments, an update to the log may include information derived from all prior transactions.

In various embodiments, a hash is generated based on one or more prior transactions. In various embodiments, a hash is generated based on all prior transactions. The hash may be a character sequence, code, or the like which results from a transformation (e.g., mathematical, algorithmic, etc.) of prior transactions. In various embodiments, each new record may include a hash of prior transactions.

In various embodiments, a party that wishes to verify the integrity of a log may check the information stored in the new record pertaining to prior transactions, and may compare this to the actual records of prior transactions. For example, the party may determine whether a hash stored with the new record can be obtained through an appropriate transformation of prior records listed in the log. If the transformation does not yield the hash (or otherwise show consistency with information stored in the new record), then the party may have reason to suspect that a prior record has been deleted from the log, or otherwise altered. This may indicate a fraud attempt whereby a seller is attempting to receive trade financing twice for the same buy/sell transaction, and has accordingly attempted to conceal prior record in the log of the same transaction.

### Blockchain

As used herein, a blockchain is a linked chain of transactions that are considered valid. The chain may include “blocks” of one or more valid transactions. Each block may include a link or reference to a prior block. The link may be a hash of the prior block.

In various embodiments, a blockchain may be implemented as a distributed or decentralized system. A blockchain may be implemented as a distributed database. Each block may be implemented as a record, and the link or hash might reside within a field of the record.

When the blockchain is updated with a new block (or blocks), the update may occur within a first instance or host of the database. This update may then get transmitted to other instances or hosts of the database so that all instances are updated with the new block.

A blockchain may include a scoring system that will give priority to one version of the blockchain when there are concurrent, conflicting updates.

Since a blockchain includes a chain of valid transactions, linked together, it may be difficult to remove a transaction or block of transactions from the chain without such removal being detected.

An illustrative implementation of blockchain technology is described in United States patent publication number 20160027229, entitled “SYSTEM AND METHOD FOR SECURELY RECEIVING AND COUNTING VOTES IN AN ELECTION”, and published Jan. 28, 2016, the entirety of which is hereby incorporated by reference herein for all purposes.

### Bill of Lading

As used herein, a “bill of lading” may include a document issued by a shipper or carrier that acknowledges receipt of a shipment of goods or cargo.

Although various embodiments described herein refer to a bill of lading, it is contemplated that other documents, records, receipts, acknowledgements, etc. having similar or related functions, may be employed, in various embodiments. For example, various embodiments contemplate the use of a transport document, receipt, or other document, or other acknowledgement.

### System

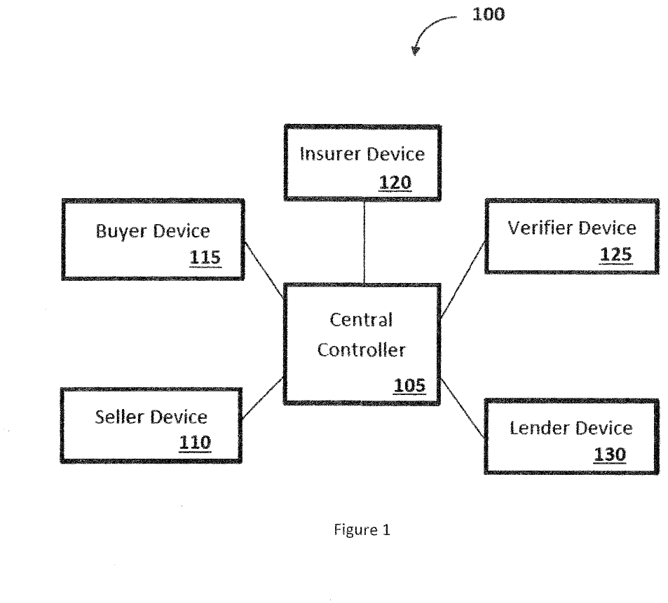

With reference to FIG. 1, a system 100 is shown according to various embodiments. A central controller 105 may be in communication with a seller device 110, a buyer device 115, an insurer device 120, a verifier device 125, and a lender device 130.

As used herein, a “device” may include a computing device, electronic device, workstation, personal computer, server, cloud, cloud server, laptop, tablet, netbook, touchscreen device, slate, personal digital assistant, smartphone, cellular phone, iPhone™, Android™ phone, iPad™, iPod™, smartwatch, internet appliance, distributed server, distributed computer, distributed cloud server, fax machine, telephone, or any other suitable device. In various embodiments, a device may comprise two or more modules or components. In various embodiments, device may be a mechanical device, electromechanical device, or any other suitable device.

As used herein, the central controller may be a device. The central controller may be a server, cloud server, distributed server, or any other suitable device.

As will be appreciated, system 100 represents a system according to some embodiments, but other arrangement, configurations, etc. are contemplated, in various embodiments. In various embodiments, there may be more or fewer devices, multiple quantities of a given device (e.g., multiple seller devices; e.g., multiple seller devices each corresponding to a different seller), more communication links between devices, fewer communication links between devices, alternative communication links between devices, etc.

In various embodiments, one or more devices and/or entities may be in communication with one another for the transfer of data or otherwise. Communication may occur via wired communication, via wireless communication, via cellular network, via the internet, via Etherne™ network, via coaxial cables, via fiber optics, via microwave links, via laser, via Wi-Fi, via bluetooth, via near field communication, or via any other suitable means. Communication may occur via voice, postal mail, courier, hand delivery, or via any other suitable means.

### Central Controller

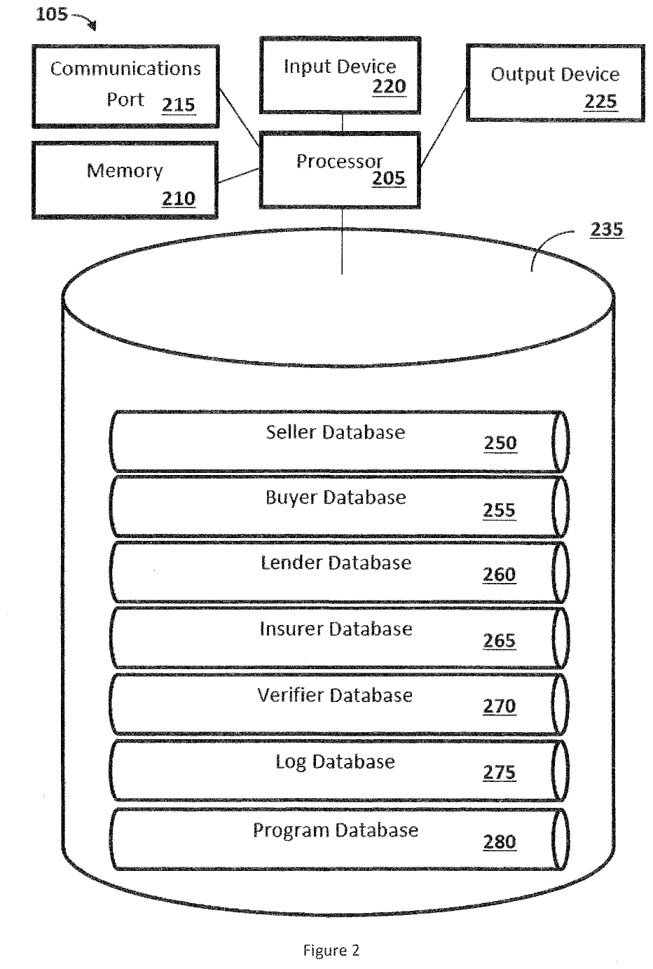

With reference to FIG. 2, the central controller 105 is shown according to various embodiments. In various embodiments, the central controller 105 may facilitate the provisioning of trade finance. The central controller 105 may serve as a meeting point, communication hub, matching point, etc. for various parties to a transaction. The central controller 105 may facilitate registration, record keeping, compliance by parties with their respective obligations, payments, funds transfer, notifications to one or more parties, feedback about one or more parties, processing of insurance claims, and or any other suitable function or action.

The central controller 105 may include a processor 205, memory 210, communications port 215, input device 220, output device 225, and storage device 230.

The processor 205 may include a central processing unit (CPU), graphics processing unit (GPU), micro-controller, controller, digital signal processor (DSP), a processor, or any other suitable component or combination of components. Exemplary components include an Intel Xeon™ processor, AMD Opteron™ processor, etc.

Memory 210 may include random access memory (RAM), dynamic random access memory (DRAM), flash memory, or any other suitable memory, or any other suitable component. Exemplary memory manufactures/suppliers include Crucial™, Samsung™, Kingston™, etc. As will be appreciated memory 210 may store data, values, variables, images, text, characters, instructions, computer code, intermediate values, calculations, etc., used during execution of one or more programs or one or more methods in accordance with various embodiments.

Communications port 215 may include a Wi-Fi transceiver, cellular transceiver, Ethernet™ port, socket, optical port, Universal Serial Bus (USB™) port, or any other suitable communication port. The central controller may communicate with one or more other devices or parties via the port. The central controller may access the Internet, a private network, the cellular network, a virtual private network, or any other network via the port 215.

Input device 220 may include any human input device, or any other input device. The input device 220 may include a keyboard, mouse, touchpad, touchscreen, microphone, camera, or other input device.

Output device 225 may include any human output device, or any other output device. The output device 225 may include a monitor, display, speaker, buzzer, vibration generator, light emitting diode, haptic feedback device, or any other output device.

Storage device 235 may include a hard disk, hard drive, array of hard drives, optical drive, or any other device. Storage device 235 may include cloud storage, network accessible storage (NAS) or any other storage. Storage device 235 may store data used in conjunction with one or more embodiments. Storage device 235 may include one or more databases. Databases may include a seller database 250, buyer database 255, lender database 260, insurer database 265, verifier database 270, log database 275. Storage device 235 may also store a program 280. As will be appreciated, storage device 235 may store other information as well, and may include additional databases as well. As will be appreciated, storage device 235 may include fewer databases as well, in various embodiments.

Aforementioned databases will be described in further detail herein. Program database 280 may include programs, computer instructions, executables, code, algorithms, etc. for operating in accordance with one or more embodiments. Programs may be executed, for example, using processor 205 and memory 210, as well as one or more other components.

In various embodiments, the central controller is accessible via Internet, web application, and/or mobile application. For example, the central controller may have an associated uniform resource locator (URL) at which a party may access information from the central controller and/or communicate with the central controller.

The central controller may host an application written using Grok™, Django™, WordPress™, Drupal™, Joomla™, Java™, Python™, Perl™, PHP™, Ruby on Rails™, C, C++, Objective C™, .NET, ASP.NET, Visual Basic™, Linux™, Unix™, SQL™, MySQL™, Apache™, and/or any other application framework, and/or any other database, and/or any other database language, and/or any other computer language.

In various embodiments, one or more parties (e.g., buyer, seller, lender, insurer, verifier) may have an account with the central controller. A party may have a username, identifier, email address, account number, password, personal identification number, security key, secret question, and/or any other means of logging in, authentication, and/or accessing the central controller.

In various embodiments, a user associated with the central controller (e.g., an administrator, employee, etc.) may access the central controller. Such a user may have an account as well.

According to various embodiments, one or more parties may access the central controller (e.g., via logging in from their respective devices), and may together enter into a transaction resulting in the provisioning of trade finance to a seller.

### Seller Device

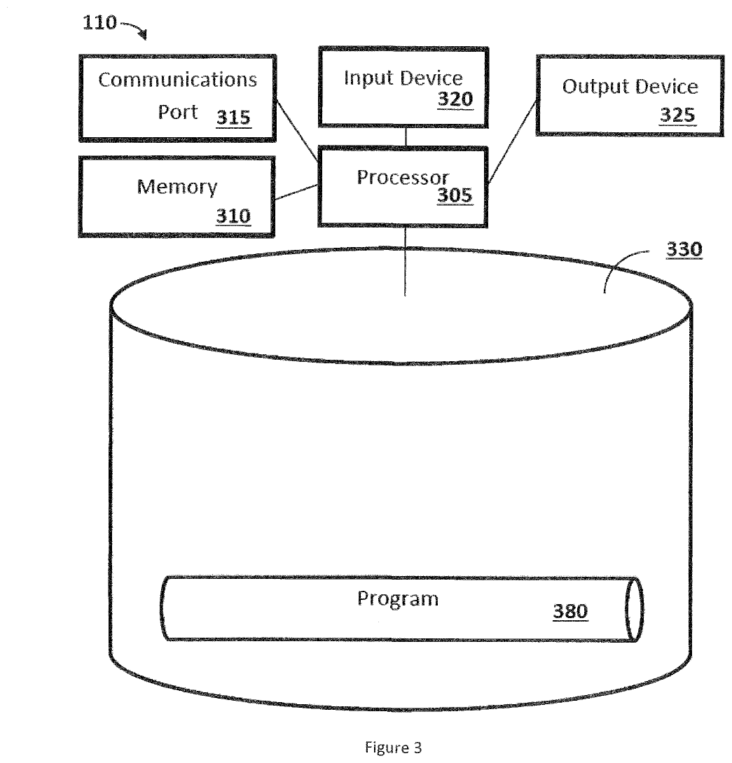

With reference to FIG. 3, a seller device 110 is shown according to various embodiments. As described herein, the seller device may be any computing device, including a personal computer, tablet, smartphone, etc., or any other suitable device. The seller device 110 may be connected to a network, such as the Internet. The seller may utilize seller device 110 to initiate and engage in communication with the central controller and/or with one or more other parties.

Seller device 110 may include a processor 305, memory 310, communications port 315, input device 320, output device 325, and storage device 330. These components may be analogous to those described above with respect to the central controller 105. However, in various embodiments, the central controller 105 and the seller device 110 need not use identical components (e.g., components of the same brand or manufacturer), or even similar components. Storage device 330 may include one or more databases, as appropriate. Storage device 330 may include a program 380 for operating in accordance with one or more embodiments.

In various embodiments, a seller may be a manufacturer, producer, processor, refiner, aggregator, and/or distributor of goods. The seller may be a trader of goods. The seller may be a broker or representative of a producer of goods. The seller may be any party with goods to sell. In various embodiments, the seller is a farmer, grower, and/or consortium of farmers. In various embodiments, the seller has commodities for sale. In various embodiments, the seller sells one or more of: (a) rice; (b) coffee; (c) raw sugar; (d) corn; (e) soybeans; and (f) soybean meal.

The seller may be engaged in overseas trade. For example, the seller may sell goods from one country to a buyer in another country. The seller may seek to utilize system 100 in order to obtain trade financing for the sale.

### Buyer Device

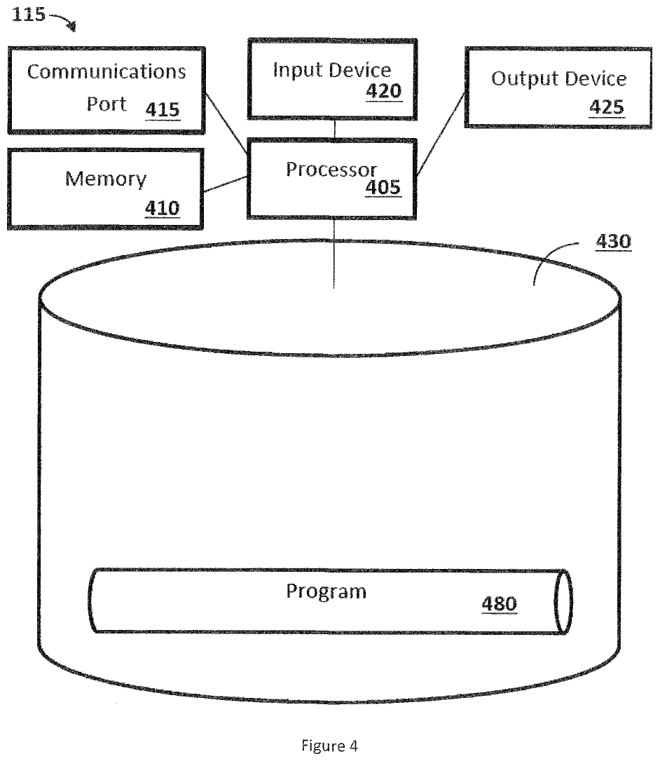

With reference to FIG. 4, a buyer device 115 is shown according to various embodiments. As described herein, the buyer device may be any computing device, including a personal computer, tablet, smartphone, etc., or any other suitable device. The buyer device 115 may be connected to a network, such as the Internet. The buyer may utilize buyer device 115 to initiate and engage in communication with the central controller 105 and/or with one or more other parties.

Buyer device 115 may include a processor 405, memory 410, communications port 415, input device 420, output device 425, and storage device 430. These components may be analogous to those described above with respect to the central controller 105. However, in various embodiments, the central controller 105 and the buyer device 115 need not use identical components (e.g., components of the same brand or manufacturer), or even similar components. Storage device 430 may include one or more databases, as appropriate. Storage device 430 may include a program 480 for operating in accordance with one or more embodiments.

In various embodiments, a buyer may be a wholesaler, distributor, refiner, processor, manufacturer, grocer, supermarket chain, and/or any buyer of goods. The buyer may be a trader of goods. The buyer may be a broker, representative, or other affiliate to a party wishing to take possession of goods.

### Insurer Device

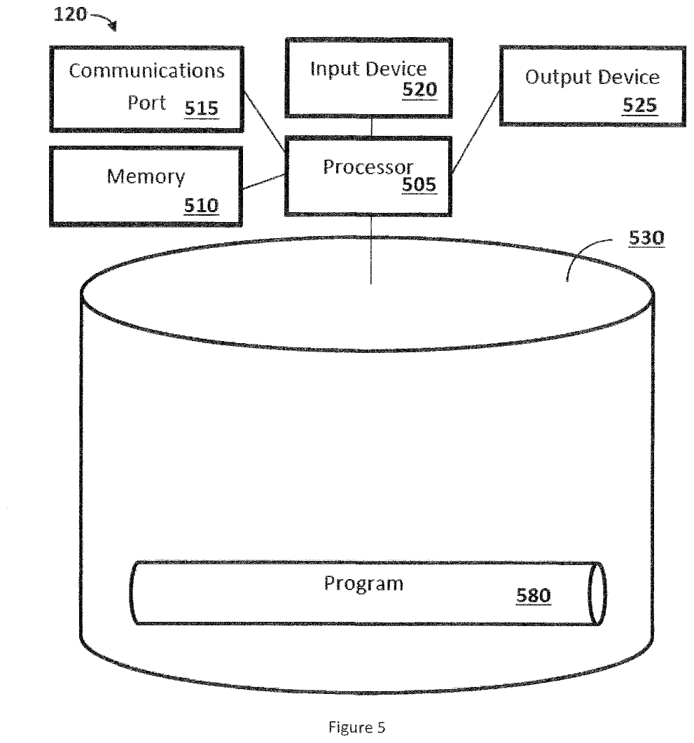

With reference to FIG. 5, an insurer device 120 is shown according to various embodiments. As described herein, the insurer device 120 may be any computing device, including a personal computer, tablet, smartphone, etc., or any other suitable device. The insurer device 120 may be connected to a network, such as the Internet. The insurer may utilize the insurer device 120 to initiate and engage in communication with the central controller 105 and/or with one or more other parties.

The insurer device 120 may include a processor 505, memory 510, communications port 515, input device 520, output device 525, and storage device 530. These components may be analogous to those described above with respect to the central controller 105. However, in various embodiments, the central controller 105 and the insurer device 120 need not use identical components (e.g., components of the same brand or manufacturer), or even similar components. Storage device 530 may include one or more databases, as appropriate. Storage device 530 may include a program 580 for operating in accordance with one or more embodiments.

In various embodiments, an insurer may issue credit insurance that pays out if a buyer defaults, becomes insolvent, and/or otherwise does not pay a seller for goods shipped to the buyer. For example, suppose buyer ABC agrees to pay seller XYZ $100,000 for a shipment of raw sugar. The insurer may provide seller XYZ with an insurance policy that will pay seller XYZ any portion of the $100,000 not paid by the buyer, provided the seller actually delivers the raw sugar to the buyer. Of course, as will be appreciated, the insurance policy may have various other terms, exceptions, etc. In return for providing the insurance policy, the insurer may receive one or more payments from the seller (e.g., insurance premiums). In this example, the seller may pay the insurer a premium of $1000. As will be appreciated, many other values for insurance policies and premiums are possible. Further, in various embodiments, insurance policies may be issued for many other types of transactions (e.g., transactions involving other types and/or quantities of goods).

In various embodiments, an insurer may issue loss insurance that pays out if goods shipped to the buyer become lost. In various embodiments, an insurance policy may pay out if goods become lost, damaged, stolen, delayed, and/or otherwise compromised. The insurance policy may pay the seller (or buyer) for any reduction in value of the goods due to loss, damage, etc. (e.g., total value for lost goods; e.g., partial value for damaged goods).

In various embodiments, more than one insurer may be used with a single buy/sell transaction. For example, one insurer may provide an insurance policy for buyer insolvency, while another insurer may provide a policy for loss, damage, etc. In various embodiments, multiple insurers may be used even with a single type of insurance. For example, a first insurer may issue credit insurance payable up to a first maximum (e.g., two thirds the value of goods), and a second insurer may issue credit insurance payable up to a second maximum (e.g., one third the value of goods).

In various embodiments, an insurance policy may be assignable. An assignee of the benefits of the policy may be termed a “loss payee”. In various embodiments, the seller may assign the insurance policy to a lender. In this case, the lender may be paid directly by the insurer in the event that a buyer does not pay for goods.

### Verifier Device

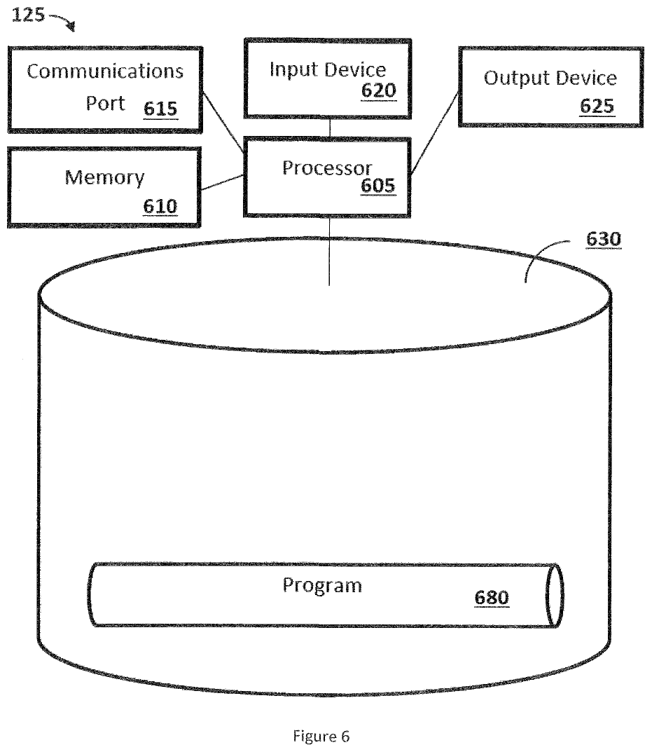

With reference to FIG. 6, a verifier device 125 is shown according to various embodiments. As described herein, the verifier device 125 may be any computing device, including a personal computer, tablet, smartphone, etc., or any other suitable device. The verifier device 125 may be connected to a network, such as the Internet. The verifier may utilize verifier device 125 to initiate and engage in communication with the central controller 105 and/or with one or more other parties.

Verifier device 125 may include a processor 605, memory 610, communications port 615, input device 620, output device 625, and storage device 630. These components may be analogous to those described above with respect to the central controller 105. However, in various embodiments, the central controller 105 and the verifier device 125 need not use identical components (e.g., components of the same brand or manufacturer), or even similar components. Storage device 630 may include one or more databases, as appropriate. Storage device may include a program 680 for operating in accordance with one or more embodiments.

### Lender Device

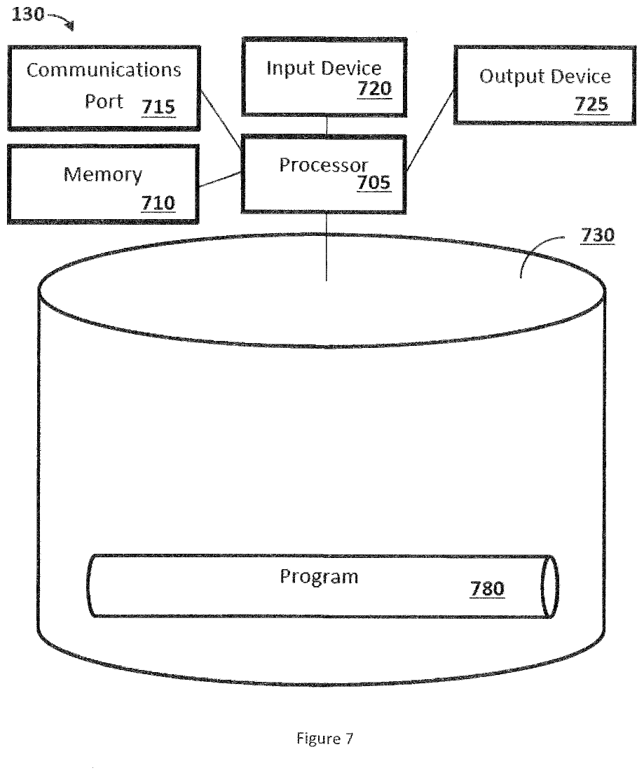

With reference to FIG. 7, a lender device 130 is shown according to various embodiments. As described herein, the lender device 130 may be any computing device, including a personal computer, tablet, smartphone, etc., or any other suitable device. The lender device 130 may be connected to a network, such as the Internet. The lender may utilize lender device 130 to initiate and engage in communication with the central controller 105 and/or with one or more other parties.

Lender device 130 may include a processor 705, memory 710, communications port 715, input device 720, output device 725, and storage device 730. These components may be analogous to those described above with respect to the central controller 105. However, in various embodiments, the central controller 105 and the lender device 130 need not use identical components (e.g., components of the same brand or manufacturer), or even similar components. Storage device 730 may include one or more databases, as appropriate. Storage device 730 may include a program 780 for operating in accordance with one or more embodiments.

### Databases

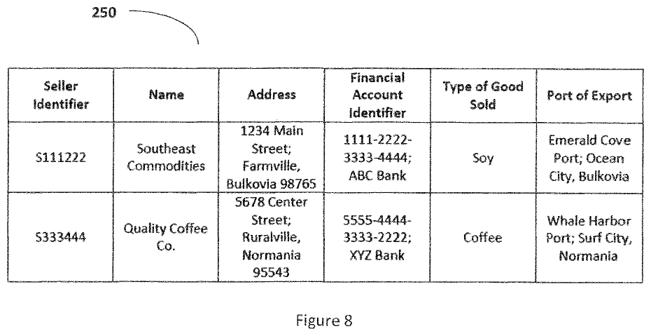

With reference to FIG. 8, a seller database 250 is shown according to various embodiments. The seller database 250 may contain pertinent information about a seller, including a seller identifier, name, address, financial account identifier, type of good sold, port of export, and/or any other information about a seller.

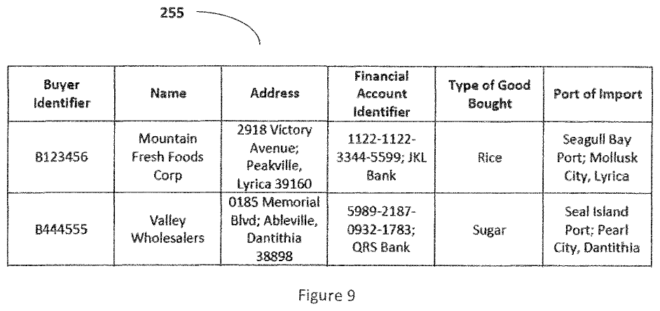

With reference to FIG. 9, a buyer database 255 is shown according to various embodiments. The buyer database 255 may contain pertinent information about a buyer, including a buyer identifier, name, address, financial account identifier, type of good bought, port of import, and/or any other information about a buyer.

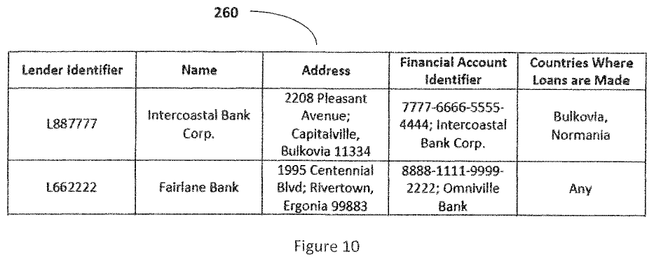

With reference to FIG. 10, a lender database 260 is shown according to various embodiments. The lender database 260 may contain pertinent information about a lender, including a lender identifier, name, address, financial account identifier, country or countries in which loans are made, and/or any other information about a lender.

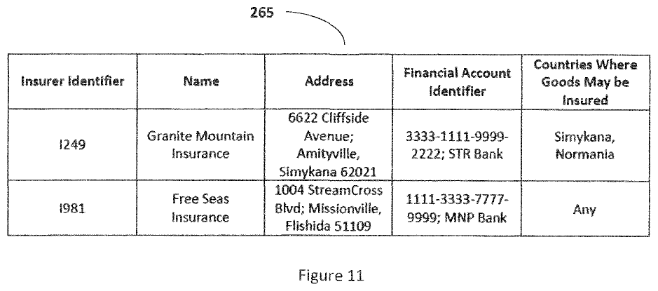

With reference to FIG. 11, an insurer database 265 is shown according to various embodiments. The insurer database 265 may contain pertinent information about an insurer, including an insurer identifier, name, address, financial account identifier, type of good insured, country or countries for which goods may be insured, and/or any other information about an insurer.

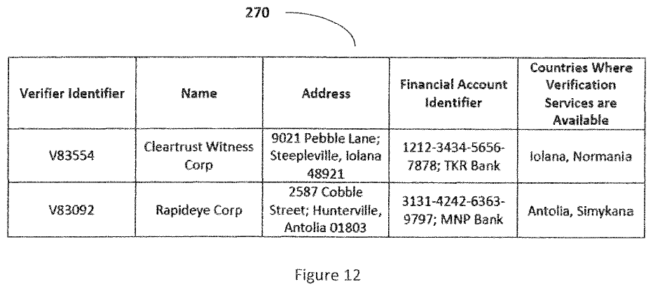

With reference to FIG. 12, a verifier database 270 is shown according to various embodiments. The verifier database may contain pertinent information about a verifier, including a verifier identifier, name, address, financial account identifier, and/or any other information about verifier.

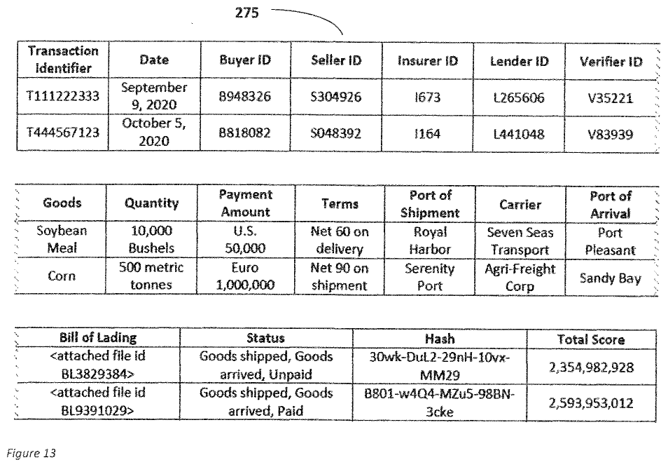

With reference to FIG. 13, a log 275 is shown according to some embodiments. As mentioned above, the log may maintain a record of transactions. The log may maintain a record of parts or portions of transactions. The log may maintain a record of documents or other information relevant to a transaction.

In various embodiments, a record or entry in a log may pertain to an individual sale of goods between a buyer and a seller. The log may record such information as a transaction identifier, date (e.g., date when the transaction was agreed), buyer, seller, insurer (e.g., an insurer who has provided the seller with credit insurance for the buyer), lender (e.g., a lender who has provided trade financing to the seller), verifier, goods sold (e.g., corn, rice, etc.), quantity of goods sold, payment amount, terms of the sale (e.g., payment terms), port of shipment, carrier, port of arrival, bill of lading (e.g., a scan of the bill of lading provided to the seller by the carrier), and a status of the transaction (e.g., goods shipped, goods arrived, unpaid, paid, etc.).

A transaction may include a hash, which may represent a transformation of information represented in previous transactions. As such, the hash may serve as a link to one or more previous transactions.

A transaction may include a score. The score may provide some indication of the currency, priority, and/or completeness of the log through the given transaction. As the log may be stored in distributed fashion, the score may be used to select one of several logs when parallel, conflicting versions of the log are available.

As will be appreciated, other items of information related to a transaction may be recorded and are contemplated according to various embodiments.

### Processes

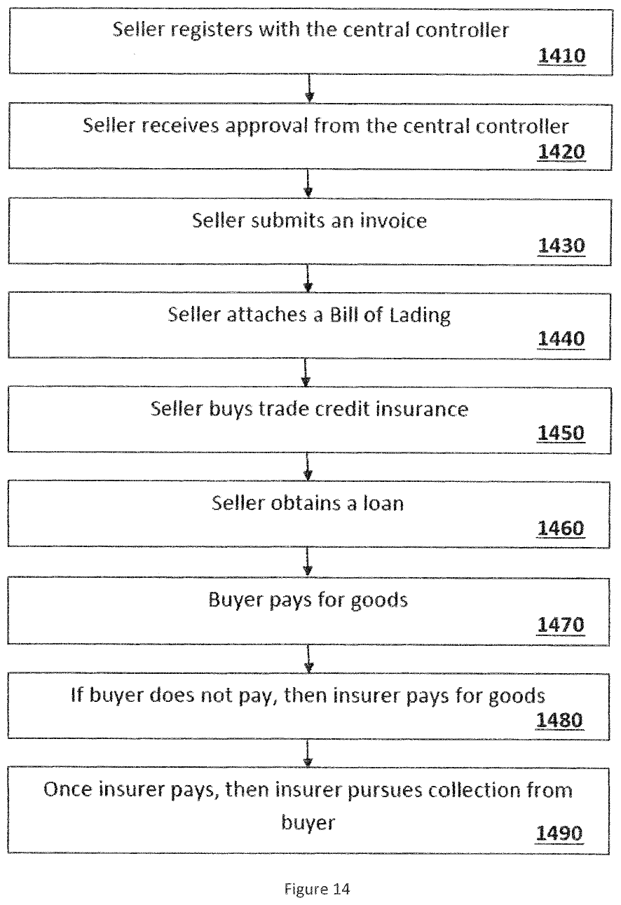

FIG. 14 is a flowchart, according to some embodiments, showing the steps undertaken by a seller.

At step 1410, the seller registers with the central controller 105. At this time, the seller may provide various items of information, such as its name, address, tax payer identification number, products sold, revenues, years in business, principal owners, officers and/or directors, and/or any other items of information. The seller information may then be verified by the central controller 105. The seller information may also or alternatively be verified by one or more other parties. In some embodiments, one or more insurers verifies the seller information.

At step 1420, the seller receives approval from the central controller 105. The seller may receive approval after the central controller 105 and/or another party has verified the seller information. Prior to the seller receiving approval, the central controller 105 (and/or another party) may determine whether the seller meets one or more criteria for approval. Such criteria may include a minimum number of years in business, minimum amount of revenues, positive references from a certain number of customers, and/or any other criteria.

At step 1430, the seller submits an invoice. The invoice may be an invoice provided to a buyer for a transaction for which the seller wishes to receive trade financing. The invoice may be submitted in various ways according to various embodiments. In various embodiments, an existing invoice can be scanned by optical character recognition (OCR). The central controller 105 may thereby automatically record one or more details of the transaction. In various embodiments, the seller may generate a new invoice through the central controller 105. For example, the seller can access an invoice template on the website of the central controller 105. The seller may then fill in the template with the appropriate transaction details, terms, and/or any other information.

Information from the invoice is extracted using technology such as Optical Character Recognition (OCR) and/or other technologies. The extracted information from the invoice is then used for determining whether the invoice meets a set of pre-determined criterion.

At step 1440, the seller may attach a bill of lading (“BL”). The BL may be for a transaction for which the seller wishes to receive trade financing. The seller may attach the BL in various ways, such as through scanning, postal mail, etc.

In various embodiments, once the BL has been submitted, the central controller 105 or an affiliated party may recognize or register details using OCR. In various embodiments, once the BL has been submitted, the central controller or an affiliated party may convert the BL into a blockchain version. In this way, the BL may be linked to one or more prior bill of ladings (e.g., BL's associated with prior transactions) and/or to one or more prior transactions. The BL may thereby be incorporated into a blockchain of BL's and/or transactions.

In various embodiments, the seller may initially submit the BL as a blockchain version.

In various embodiments the BL is submitted as, or converted to, a BL that is a secure digital blockchain version.

In various embodiments, the central controller 105 and/or affiliated party (e.g., the verifier device 125) may verify the BL. The central controller 105 may match one or more details of the BL with one or more details of the invoice in order to verify that the two match. The central controller 105 may verify one or more other details, such as the authenticity of any brand/logo/insignia on the BL, the identity of the carrier, the location of the port of shipment, the dates of the shipment, and/or any other detail.

In various embodiments, the BL may be compared to an external record of BL's. For example, copies of BL's may be stored in an external database, such as databases associated with respective ports of shipment. If the BL submitted by the seller matches an external record, then the BL submitted by the seller may be considered verified.

In various embodiments, the central controller 105 may verify that the BL meets one or more criteria before the BL is approved. In various embodiments, only original BL's are accepted. In various embodiments, only original BL's “to order” are accepted. In various embodiments, only original BL's “to order” on blockchain are accepted.

In various embodiments, at step 1450, the seller buys trade credit insurance for the sale of goods. In various embodiments, the seller buys trade credit insurance for the invoice and BL.

In various embodiments, the central controller 105 determines the price of the trade credit insurance automatically. The price may be determined based on one or more factors. Such factors may include payment terms (e.g. net 30, net 60), the amount paid for the goods, the credit rating of the buyer, the reputation of the buyer, the years in business of the buyer, the destination of the goods, and/or any other factors. For example, the trade credit insurance may be priced at 0.5% of the amount paid for the goods multiplied by the number of days before payment is due divided by 30 days (e.g., $100,000 paid×0.5%×120 days/30 days=$2000). As will be appreciated, insurance may be priced in various other ways.

In various embodiments, terms of the sale of goods may be presented to various insurers, and the insurers may determine prices at which to offer insurance.

In various embodiments, the seller may approve an offer for insurance and accept the purchase of the insurance. In various embodiments, payment for the insurance (e.g., premiums) may be automatically deducted from the financial account of the seller. The payment may be transferred to the insurance company. As will be appreciated, payment may be received in various other fashions.

At step 1460, the seller may obtain a loan. In various embodiments, a lender may agree to provide a loan (e.g., trade finance) to the seller. The lender may provide the loan once the lender ascertains the amount of an invoice the seller has issued to the buyer, the authenticity of the BL, that the seller has obtained trade credit insurance and/or any other information about the transaction. The lender may be a bank, financial institution, or any other party.

The amount of the loan may be deducted from the financial account of the lender. The amount of the loan may be transferred to a financial account associated with the seller. The amount of the loan may be automatically transferred to the seller's registered bank account. In exchange, a notice of assignment may be issued (e.g., automatically) to the lender.

At step 1470, the buyer may pay for the goods. For example, the buyer may pay 60 days after receipt of the goods. In various embodiments, the payment may be transferred directly from the buyer to the lender. The payment from the buyer may therefore be used to repay the loan to the seller. In various embodiments, payment may be made via omnibus bank account of the central controller 105, directly transferred to lender/financier/loss payee's bank account.

At step 1480, in the event that the buyer does not pay for the goods by the payment due date (e.g., as detailed on the invoice), then the insurer may pay out on the credit insurance. The central controller 105 may notify the insurer (e.g., automatically) that the buyer has not made payment in time. In various embodiments, the central controller 105 may generate and/or submit a claim for the insurance (e.g., automatically). The claim may be generated automatically when no payment is received from the buyer by the payment due date. In various embodiments, the claim may be generated automatically when no payment is received from the buyer by the payment due date plus some predetermined number of days (e.g., 30 days after the payment due date).

The insurance pay-out may then be deducted (e.g., automatically) from a financial account of the insurer, and may be transferred (e.g., automatically) to a financial account of the lender.

At step 1490, in various embodiments, the insurer may then take responsibility for collecting payment from the buyer.

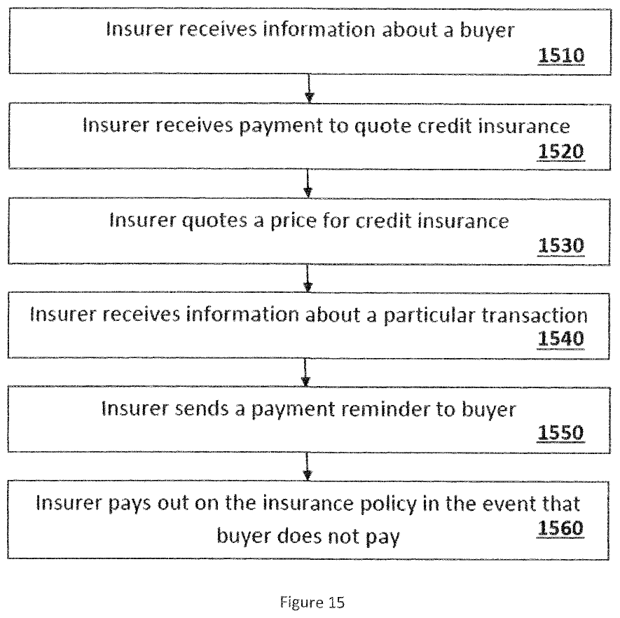

Referring to FIG. 15, a process flow is shown according to some embodiments. The process flow represents steps taken by an insurer according to various embodiments.

At step 1510, the insurer may receive information about a buyer. The buyer may be a buyer with whom a particular seller wishes to transact with. The seller may provide an indication of the prospective or current buyer. The insurer may receive various information about a buyer. Such information may include assets, revenues, number of historical sales that have occurred between the buyer and the seller, number of historical sales that have occurred to the buyer, and/or any other information about the buyer.

At step 1520, the seller, the central controller 105, or any other party may provide a payment to the insurer to quote credit insurance against the buyer.

At step 1530, the insurer may determine a price, premium amount, or other payment required for the insurer to provide credit insurance against the buyer. The premium may be a function of a given sale. For instance, the premium may vary with the quantity of goods purchased during a given transaction. However, even in the absence of a concrete transaction, the insurer may determine an algorithm or other formula for determining a premium based on the parameters (e.g., price paid for goods) of a sale. For example, a premium may be determined as 0.75%×price paid for goods. In various embodiments, the insurer may specify a set of terms or criteria that a sale must meet in order for it to qualify for credit insurance. For example, the insurer may set a limit of a maximum price paid for goods and/or a maximum number of days which may transpire before payment is due.

At step 1540, the insurer may receive information about a particular transaction. The information may include a price to be paid for goods, a type of goods, payment terms, and/or any other information about transactions. The insurer may then determine a premium required for credit insurance on the transaction. In various embodiments, the insurer uses the previously determined formula, algorithm, etc., as applied to the particular transaction. The insurer may then inform the central controller 105, seller, and/or any other party about the required premium. In various embodiments, the central controller 105 and/or another party may possess the algorithm used by the insurer. Accordingly, the central controller 105, seller, and/or other party may use the insurer's algorithm together with information about the transaction to automatically calculate or otherwise determine a premium.

At step 1550, the insurer may send a payment reminder to a buyer (or buyer representative, affiliate, broker, etc.). The payment reminder may be sent based on the terms of payment (e.g., as derived from the invoice associated with the transaction). The payment reminder may also be sent based on the current date. For example, a payment reminder may be sent 10 days before payment is due. In various embodiments, the central controller 105 may send out payment reminders automatically on behalf of the insurer. Payment reminders may be sent in various ways, such as via email, text, phone call, postal mail, or the like. A record or log of payment reminders sent may be maintained by the central controller 105.

At step 1560, if a buyer has not made payment as required by the terms of a transaction (e.g., as detailed on an invoice), then the insurer may make the appropriate insurance pay-out. In some embodiments, the buyer must be in default for a certain number of days (e.g., 60 days) before the insurer makes the payment. The pay-out may go to the loss payee (e.g., lender; e.g., seller). The pay-out may be deducted automatically by the central controller 105 from the account of the insurer and transferred to the account of the loss payee.

In various embodiments, the insurer may also initiate a collections process to collect payment from the buyer.

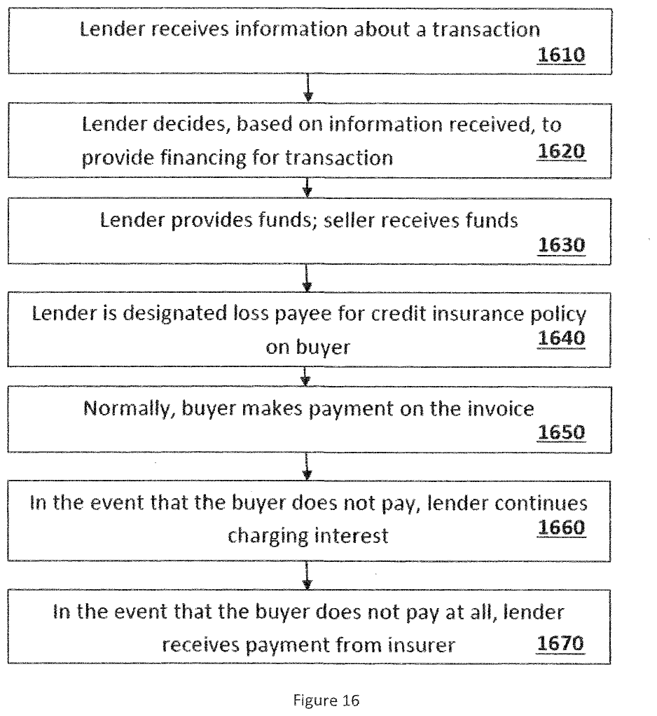

Referring to FIG. 16, a process flow is shown according to some embodiments. The process flow represents steps taken by a lender or financier according to various embodiments.

At step 1610, the lender may receive information about a transaction. The lender may receive information about a transaction for which a seller desires trade financing. The lender may receive information about all available transactions for which sellers are seeking financing. The lender may receive information about transactions meeting criteria specified by the lender. For example, the lender may have criteria for a transaction, which may include a minimum financing amount requested, a maximum financing amount requested, a particular location of the seller, a particular location of the buyer, a type of goods, a size of the buyer (e.g., in terms of revenue), a size of the seller, a credit rating of the insurer, and/or any other criteria.

The lender may receive information about a transaction via the central controller 105. In various embodiments, the lender may receive an alert about a new transaction, a periodic listing of available transactions, or any other notification or communication about available transactions. In various embodiments, the lender may actively search for available transactions. The lender may search, for example, using specified criteria (e.g., transaction size, etc.)

In various embodiments, the lender may receive documents or other information associated with a transaction. In various embodiments, the lender may receive a copy of an invoice (e.g., an invoice provided to the buyer by the seller), a credit insured invoice, a bill of lading, and/or any other information or documentation.

In various embodiments, the lender may receive background documents about a buyer, seller, insurer, or other party. Such documents may include licences, certificates of formation, certificates of incorporation, or any other background information.

At step 1620, based on information the lender receives about a transaction, the lender may decide to provide trade financing for the transaction. The lender may match information received against a set of criteria. The lender may use a scoring system, algorithm, or any other means of deciding whether or not to provide financing. In various embodiments, the lender provides an algorithm, set of criteria, scoring system, and/or other evaluation methodology to the central controller, and the central controller may then apply the criteria automatically to determine whether the lender will provide financing.

In various embodiments, the amount of financing provided may depend on one or more factors. Such factors may be related to the transaction and/or to transaction participants. In various embodiments, the amount of financing provided may be a percentage of the invoiced amount (e.g., 100%, e.g., 90%). In various embodiments, amounts may be deducted from the funds provided (e.g., amounts may be kept by the lender, the central controller, and/or by another party). Amounts deducted may include interest charges, transaction fees, currency conversion fees, fees, and/or other charges.

At step 1630, funds may be provided to the seller. The funds may be transferred (e.g., automatically) from a financial account of the lender to a financial account of the seller.

At step 1640, the lender may be designated as the loss payee for a credit insurance policy taken out by the seller on the buyer. In this way, in the event that the buyer does not make satisfactory payment on the invoice, the lender can receive payment from the insurer instead. In various embodiments, if there are other insurance policies related to the transaction (e.g., insurance on loss, damage, etc.) then the lender may be made the loss payee on these as well.

In various embodiments, the lender may receive a notice of assignment of an insurance policy. In various embodiments, the lender may receive such a notice automatically from the central controller 105 upon providing trade finance to the seller.

At step 1650, the buyer makes payment on the invoice. Such payment may then go to the lender. In various embodiments, if the lender has not financed the full amount of the invoice, then the lender may only receive funds from the buyer equal to the amount funded. For example, if the lender has only provided financing equal to 50% of the invoiced amount, then the lender may receive from the buyer 50% of the invoiced amount. In various embodiments, from proceeds provided by the buyer, the lender may receive repayment for the loan plus any applicable interest charges, overdue interest, late fees, transaction charges, currency conversion fees, and/or any other fees.

In various embodiments, payment may be added automatically to a financial account associated with the lender. In various embodiments, payment may flow through the central controller. For example, the buyer may pay the central controller 105 which may then (e.g., immediately) pay the lender. In various embodiments, the central controller 105 provides payment instructions, but does not handle funds itself. For example, the central controller 105 may instruct the buyer's bank to pay the lender's bank, but may not handle the funds itself. As will be appreciated, various embodiments contemplate that funds may be transferred from buyer to lender in various other ways, with or without mediation of the central controller 105.

At step 1660, in the event that a buyer does not pay on an invoice by the payment due date, the lender may keep charging interest on the loaned amount. In various embodiments, the interest rate may stay the same. In various embodiments, the interest rate may increase because payment is overdue.

In various embodiments, the lender may send out one or more notifications to the buyer (or to the seller, or to any other party) about the late status of the repayment.

In various embodiments, notifications may be sent out (e.g., automatically) by the central controller.

At step 1670, in the event that the buyer does not pay at all (e.g., within a predetermined number of days after payment is due; e.g., within 60 days after payment is due), then the lender may receive payment as the loss payee from the insurer. In various embodiments, the lender may submit a claim prior to being paid. In various embodiments, the central controller submits a claim automatically on behalf of the lender.

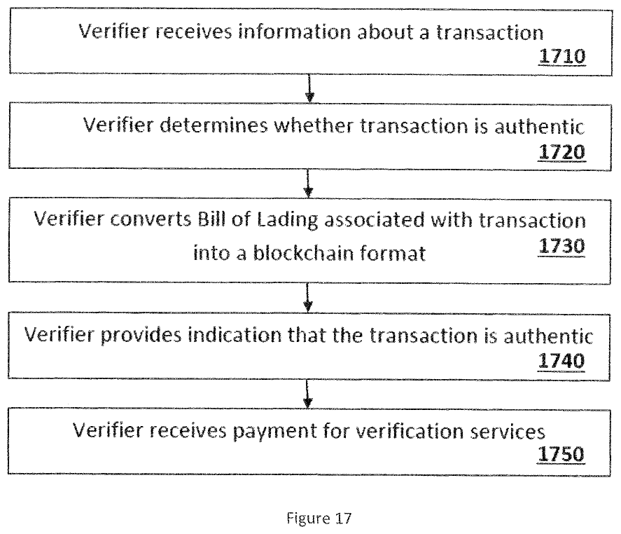

Referring to FIG. 17 a process flow is shown, according to some embodiments, representing steps taken by a verifier.

At step 1710, the verifier receives information about a transaction (e.g., a sale of goods between a buyer and a seller). Information may include an identity of the buyer, identity of seller, port of shipment, port of delivery, date of shipment, carrier, nature of goods, and any other information. The verifier may receive documents related to the transaction. Documents may include a Bill of Lading, invoice, and/or any other document.

At step 1720, the verifier determines whether the transaction is authentic. The verifier may determine, for example, that the buyer and/or seller actually exist, that specified goods were actually transferred to a particular carrier at a particular port on a particular day, that the goods were of the nature/condition specified, and/or that any other details of the transaction occurred. The verifier may have access to separate or independent records, logs, etc. (e.g., independent from those of the central controller), and may thereby have a means of independently verifying one or more aspects of a transaction.

At step 1730 the verifier may convert a Bill of Lading associated with the transaction into a blockchain format.

At step 1740, the verifier may indicate that an aspect of the transaction (or the entire transaction) is authentic. For example, the verifier may send a notice to the central controller (and/or to any other party) indicating that the transaction is authentic.

At step 1750, the verifier may receive payment for its verification services. For example, the funds may be transferred (e.g., automatically) into a financial account associated with the verifier. In various embodiments, the verifier's fee is paid by the lender. As such, funds may be received from the lender (e.g., at the central controller) before being provided to the verifier.

Herein are described steps, processes, and/or flows according to some embodiments. It will be appreciated that contemplated embodiments are not restricted to these specific descriptions. Rather various steps may be performed in a different order, steps may be added, steps may be omitted, steps may be combined, additional decision branches may be introduced, etc., and still fall within the scope of contemplated embodiments.

### Pricing

In various embodiments, the central controller 105 may receive one or more fees, commission, and/or other payments for providing its services. The central controller 105 may provide services that include matching two or more parties (e.g., buyer, seller, insurer, lender, verifier), transferring funds, sending notifications, maintaining transaction logs, expediting claims processing, expediting document creation (e.g., invoices; e.g., bills of lading in blockchain format), or any other services.

In various embodiments, the central controller 105 may charge a fee to a seller. The fee charged may be a percentage of the invoice/transaction value.

In various embodiments, the central controller 105 may charge a fee to a lender. The fee charged may be a percentage of revenues to the lender. The fee charged may be a percentage of interest received by the lender for a loan facilitated by the central controller 105.

In various embodiments, the central controller 105 may charge a fee to an insurer. The fee charged may be a percentage of revenues received by the insurer. The fee charged may be a percentage of premiums received by the insurer for a transaction facilitated by the central controller.

In various embodiments, the central controller 105 may charge a fee to any other party, or to any combination of parties.

In various embodiments, the central controller 105 may charge a fee which is determined according to any suitable formula, algorithm, etc. For example, the central controller 105 may charge a lender a fixed transaction fee (e.g., $1000 per transaction) plus a percentage of interest revenue received by the lender.

In various embodiments, fees charged by the central controller may be deducted from the respective financial accounts of one or more other parties.

### Platform Integration with Technologies

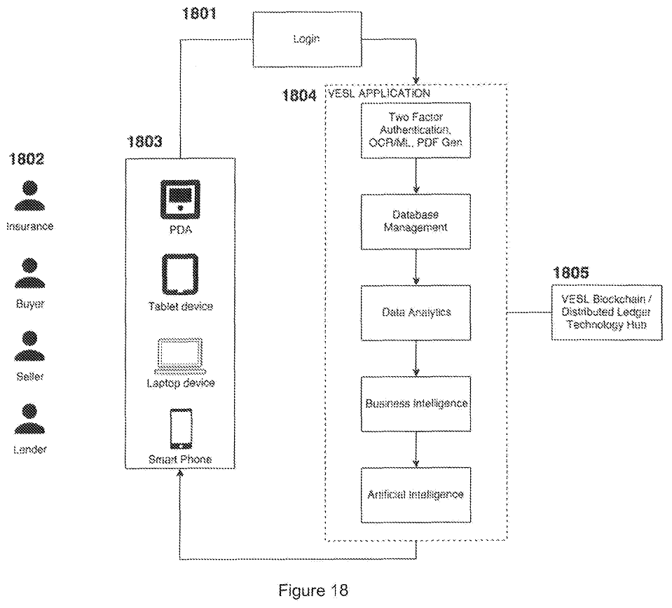

FIG. 18 illustrates the summary flow of the platform invention 1801 and its integration with possible compatible technologies.

Users 1802 may access the platform via different devices 1803 including, but not limited to, laptops, tablets, mobile phones, and personal digital assistants (PDAs). To enhance efficiency, security, and communication among main parties involved in trade, as well as trade facilitating parties, some auxiliary technology and systems 1804 are integrated. This includes, but is not limited to, two-factor authentication, OCR, machine learning (ML), database management, data analytics, business intelligence (BI), artificial intelligence (AI) and application programming interface (API).

The platform integrates blockchain/distributed ledger technology 1805 to secure the validity of transactions. This is a decentralized/distributed system where a blockchain is a linked chain of transactions, and each new transaction forms a new block. As each change in the link is distributed/shared with the network, with each device in the network acting as authenticators, transactions recorded in the blockchain are more difficult to tamper with.

Process Flow of Shared Information

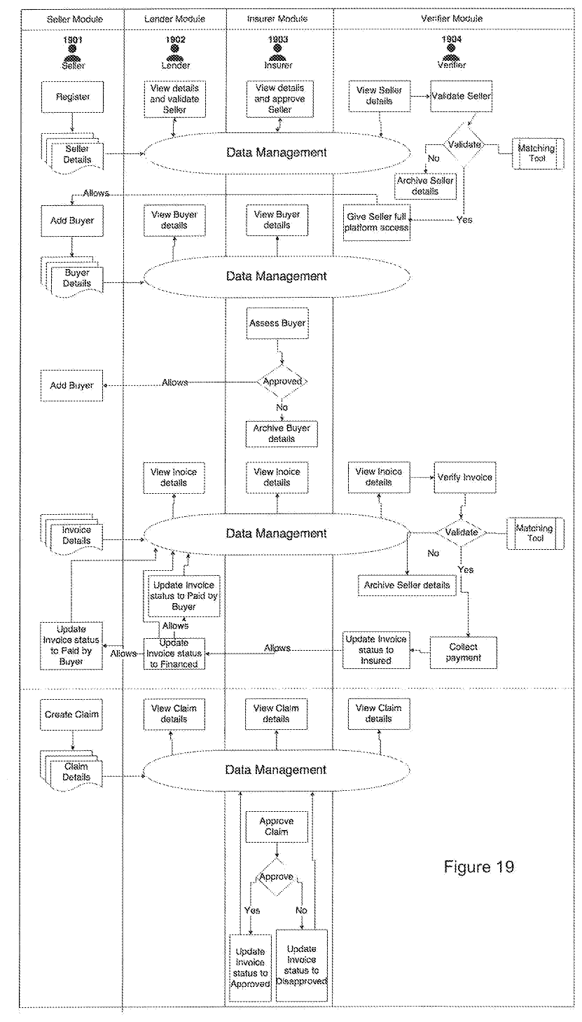

FIG. 19 is a flow chart outlining steps that may be taken by different users via the invention platform.

First, the seller 1901 registers on the platform. At this time, the seller may provide various items of information, such as its name, address, tax payer identification number, products sold, revenues, years in business, principal owners, officers and/or directors, and/or any other items of information. Seller information may then be verified by the central controller 105. Seller information may also or alternatively be verified by one or more other parties. In some embodiments, one or more lenders 1902, insurers 1903 and verifiers 1904 validate the seller information.

With access to the platform, the seller 1901 may proceed to adding buyers for assessment. The buyer may be a buyer with whom a particular seller 1901 wishes to transact. The seller 1901 may provide an indication of the prospective or current buyer. Such information 1905 may include registration number, address, assets, revenues, number of historical sales that have occurred between the buyer and the seller, number of historical sales that have occurred to the buyer, and/or any other information about the buyer. The assigned lender 1902 or insurer 1903 may be able to view submitted information on the buyer.

The insurer 1903 may be able to receive information on the submitted buyer, assess buyer risk, and provide a credit limit to the buyer if the buyer passes the assessment. In various embodiments, the insurer 1903 may specify a set of terms or criteria that a sale must meet in order for it to qualify for credit insurance. For example, the insurer 1903 may set a limit on the maximum number of days which may transpire before payment is due. Buyer information and assessment results are recorded.

For approved buyers, the seller 1901 may proceed to upload invoices 1906 for insurance. The invoice may be an invoice provided to a buyer for a transaction for which the seller 1901 wishes to receive trade financing. The invoice may be submitted in various ways according to various embodiments. The seller 1901 may be prompted to provide other documents, such as transport documents (e.g. bill of lading), proof of delivery, purchase order, contract, and other documents on the transaction for cross-verification. In various embodiments, documents can be scanned by OCR. The central controller 105 may thereby automatically record one or more details of the transaction. Information may include an identity of the buyer, identity of seller, port of shipment, port of delivery, date of shipment, carrier, nature of goods, and any other information. These are made available to the lender 1902 and insurer 1903.

Upon verification of transaction authenticity and receipt of payment, the verifier 1904 may proceed to approve the transaction for insurance. Once insured, the seller 1901 may submit the invoice to a lender 1902 for financing. Once the buyer has paid for the goods/services invoiced, the invoice/transaction is marked as paid. All status updates on the invoice/transaction are recorded.

In the event of delayed payment or buyer default, seller may request for claims via the platform. The claim will include details such as the type of claim, recovery effort, and information on the transaction. The insurer and lender may view claims details. The insurer may approve or disapprove of the claim. Once approved/disapproved, the claims status for the invoice is updated and recorded.

### Optical Character Recognition and Machine Learning

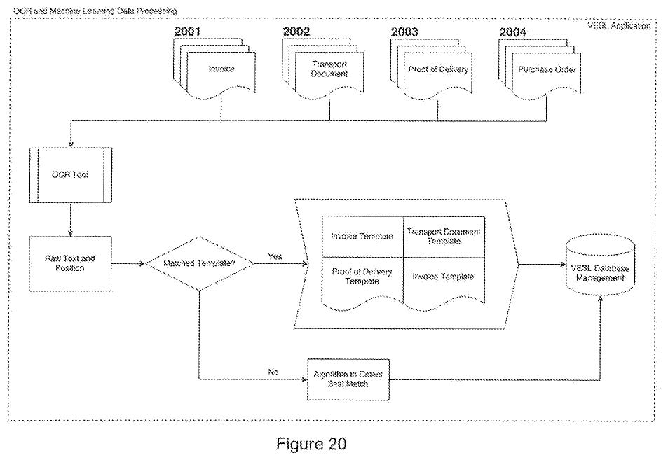

FIG. 20 depicts the use of OCR and ML to scan documents, such as invoices 2001, transport documents 2002, proof of delivery 2003, and purchase orders 2004, for cross-checking details of the transaction.

OCR is used for converting images with text (whether typed, handwritten or printed) and translating them to digital text which can then be used for data processing. Original images can be produced by scanners, cameras, etc, and be in a PDF, jpeg, png, bmp, tiff, and other formats. Color/grayscale images are converted into binary images, and pre-processing is done by improving image quality, removing noise and adjusting the orientation of images. Text positions are then detected, and errors created by broken/merged text are corrected. Once this is done, characters are recognized and converted to a text format.

Upon submission of the scanned documents, an OCR tool 1905 is used to detect, retrieve and match information including, but not limited to, the product, stock keeping unit (SKU), volume, value, sender, and buyer in a template database 2005. A match allows the user to proceed with the submission of invoices for insurance. Results of the OCR scan are recorded.

OCR may be used with ML, which will improve the tool by giving it the ability to predict where important inputs can be found in the template images/files uploaded. ML can be supervised or unsupervised. Training data may initially be fed to the platform, with target output being compared with output from the machine. Adjustments to the predictive algorithm will be made accordingly.

### Integration with Blockchain/Distributed Ledger Technology

Blockchain technology works via internet, wherein an increasing number of records and transactions are held. These data are stored across network of computers called nodes. Whenever a transaction occurs, like orders, payments and account tracking, records of transactions are placed into blocks. Each block contains four major information: A hash identifier, the hash number from the previous block, transactions included in the block, and a public key for the sender and receiver.

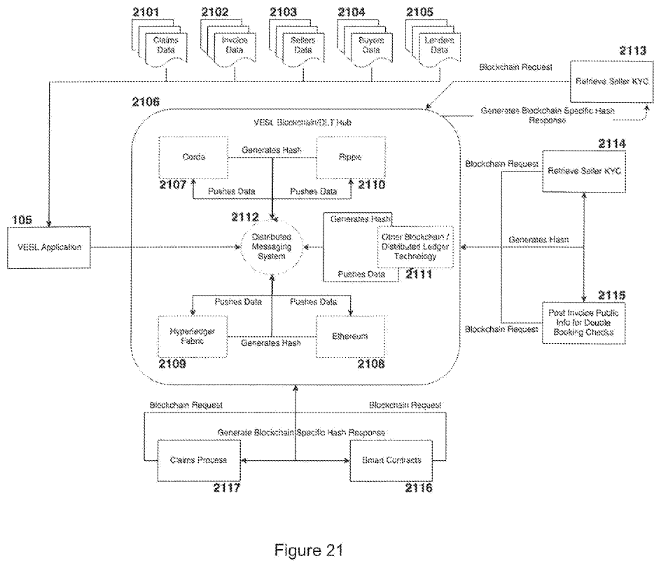

As shown in FIG. 21, one or more transactions in the platform occur among insurers, sellers, lenders and buyers. These transactions produce or generate data such as claims data 2101, invoice data 2102, sellers data 2103, buyers data 2104 and lenders data 2105. Such data may be stored in one or more databases. The information in the one or more databases are then communicated to the central controller 105.

Specific transactions may be distributed to a Blockchain/Distributed Ledger Technology (DLT) Hub 2106 to send or receive information to several platforms such as Corda™ 2107, Ethereum™ 2108, Hyperledger Fabric™ 2109, Ripple™ 2110, and/or other emerging blockchain and DLT technologies 2111.

The Blockchain/DLT hub 2101 can be managed using a distributed messaging system, which will circulate information to all blockchain networks. 2112. A publish-subscribe system is used to implement data layering for more efficient information circulation. In this case of data layering, data is filtered on an as needed basis, where only nodes subscribed to certain topics/groups will get information distributed to those group(s) subscribed to the topic(s). It is to be appreciated that information is typically not distributed to all nodes or members of the network. For instance, an update on an invoice being financed will be distributed only to the trade finance subset, and will not be distributed to the whole banking/lending group. As another example, the same update on the invoice being financed may also be sent to the trade insurance subset, but not to the whole insurance group.

Blockchain-specific hash responses will be generated from each of the platform for every update of data/information on transactions. A hash is an encrypted value representing the original data as a series of letters and/or numbers. This is used to make data more secure, and unreadable to unauthorized viewers.

Information may be extracted from or shared to the network such as the retrieving of seller and buyer “know-your-client” information 2114, posting invoices 2115 for verification of the possibility of double financing or double insuring. Once the invoice status is shared via the blockchain hub, different nodes will confirm the validity of this status. Hence, invoices that are financed cannot be refinanced and invoices that are already insured cannot be re-insured.

The blockchain/distributed ledger can be used for recording and posting transactions, using smart contracts 2116 for the exchange of ownership of the invoice, for the management of insurance policies such as facilitating the claims process 2117 and other obligations among platform users. Smart contract technology act as a vending machine for contracts, establishing requirements before the release of each contract and the fulfilment of contract obligations between parties. Requirements may include business documents, transaction documentation, delivery documents, purchase orders, payment, and others. Smart contracts can be used for agreements between lenders and sellers, sellers and insurers, lenders and insurers, the invention platform and sellers, the invention platform and insurers, and others.

### Business Intelligence

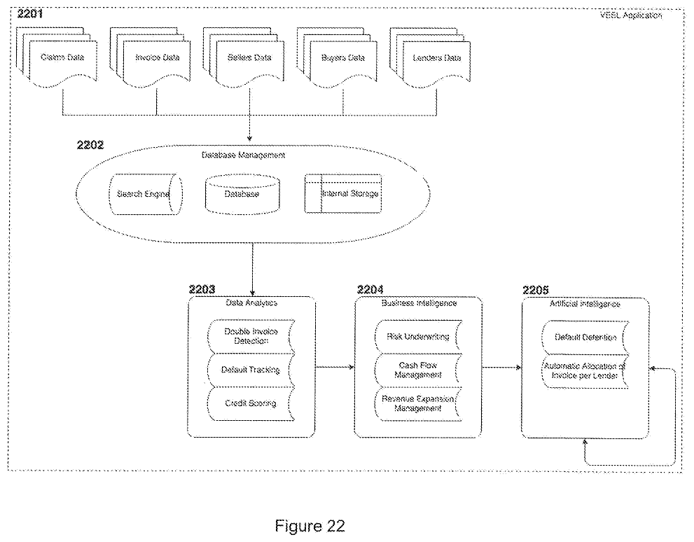

The process of Business Intelligence starts with the gathering of data through the invention as shown in FIG. 22. Data 2201 includes, but is not limited to, sellers, buyers, lenders, invoices and claims. These will be collected in various formats such as JPEG™, CSV™, PDF™ or HTML™ form, wherein various sanitation and validation techniques will be implemented. Upon ensuring that data collected are safe and relevant, these will be stored in a data manager 2202 including a database, search engine and internal cloud storage like Amazon™ S3, Microsoft Azure™ and Google Cloud™.

From the process of gathering of information, data management will be administered to provide solutions for Data Analytics 2203, Business Intelligence 2204 and Artificial Intelligence 2205. Data management is the process of acquiring, protecting, organizing and managing data. The invention platform aims to provide better Data Analytics 2203 by creating an algorithm that answers questions such as:
a. When are the lean and peak months for certain industries/sectors? How much does the value of transactions differ from the monthly average?
b. What is the default rate per country?
c. What is the default rate of local versus foreign buyers?
d. What is the rate and average payment delay per country, per industry, and invoice value range?
e. What is the rate and average payment delay in local versus foreign transactions?
f. What is the fraud rate per country and per industry?
g. What step in the transaction does fraud usually occur in?
h. What are the main variables correlated with default and fraud? How much the predictive capability of these variables?
i. What industries are correlated? How much do increases in demand for certain industries affect other industries?

By recording and tracking specific data from different users, patterns in user behaviour and transactions, the platform may provide business intelligence on risk management, cash flow management, and even revenue generation. Credit risk, for instance, will not simply be based on macroeconomic, industry and financial risk, but will be able to take into account payment and risk avoidance patterns of the parties to the transaction. In this stage, analytics is transformed from being descriptive to diagnostic. Reasons for profit drop can be diagnosed from the cash flow management (limits revenue) or risk management (increases cost) perspective.

By utilizing correlations, diagnostic, and behavioural observations recorded on the platform, the application of artificial intelligence may further improve user experience. Predictions on risk, such as payment delays, fraud, default, may be made. Increases in market demand, cash demand, etc. may also be predicted, and recommendations/prompts for actions such as request/provision of additional credit limits, additional financing facilities, and even recommendation on lending/insurance partners based on requirement and behavioural matches may be made via the platform.

### Authentication

Nowadays the internet is more exposed than ever to cyber security attacks such as phishing, SQL injection, cross-site scripting, etc. In all of these attacks, the hacker can usually access and make use of a user's credentials (username and password). With Two Factor Authentication (2FA), use of another piece of information that only the user has, such as a token, is required. This gives an extra layer of security to the invention platform.

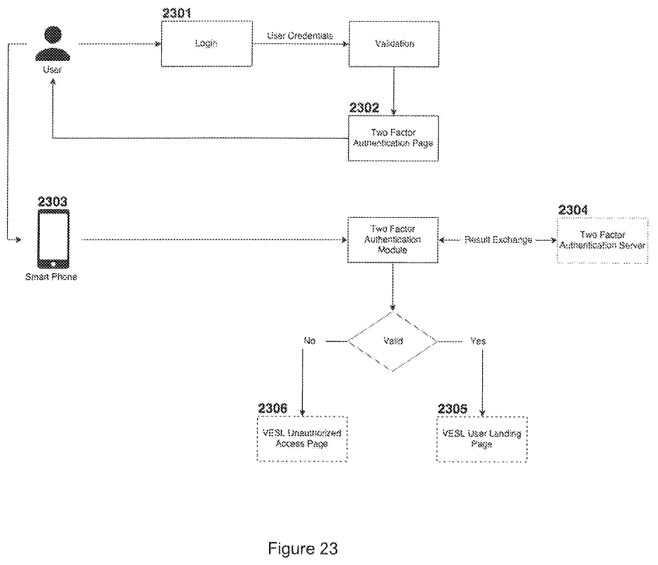

FIG. 23 illustrates an example of how 2FA can be used with the platform invention.

The user will login 2301 to the website with his credentials. A program will be executed to authenticate if the email and hashed password in the database exists and matches. After validating, the server will return a response to the user's browser. If the response is successful, it will proceed to the Two Factor Authentication page 2302.

The invention may use Google Authenticator™ as the 2FA tool. Other authenticators could also be used. Google Authenticator™ is a time-based one-time password wherein a unique code is generated on the user's device. To use it, the user needs to install the application on a mobile device 2303. When the 2FA page asks for the token, the user will get it from the application and submit it manually. The server 2304 and the client will generate the same exact code based on a shared key and time to compare and check the login request. A successful login will redirect the user to a specific landing page 2305 of the invention. Otherwise, the user will not be able to access the platform and will be redirected to an Unauthorized Access page 2306. The number of failed attempts will be recorded.

### Matching

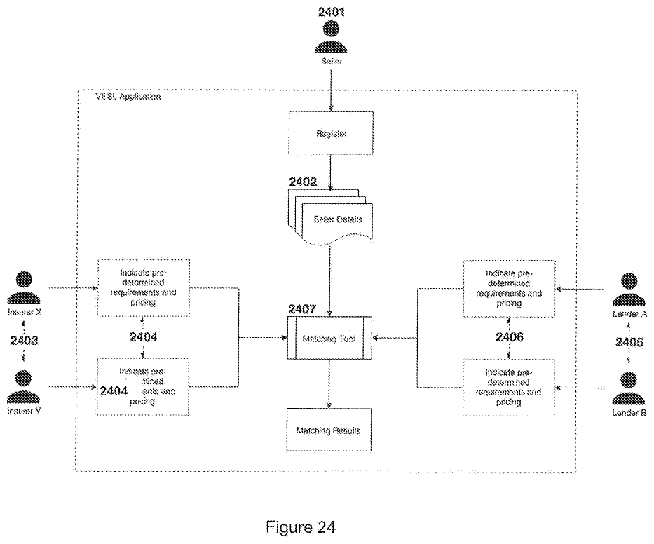

FIG. 24 illustrates a matching process enabled by the invention method.

The seller 2401 will register with the invention platform and provide his/her details 2402. Insurers 2403 will provide their various pre-determined requirements and pricing 2404. Lenders 2405 will provide their various pre-determined requirements and interest rates 2406.

Given pre-determined requirements and pricing from lenders and insurers, the invention, in various embodiments, uses a tool 2407 to match and tag sellers to a specific insurer and lender. Information to be used for matching may include location, industry, volume of turnover, average invoice value, pricing, payment terms, and other details.

In view of the foregoing description, it can be appreciated that the invention solves the problem of premiums being paid on the entire projected turnover for the year at the beginning of a period where the minimum premium paid could cost at least USD $10,000. The invention changes the way businesses pay for premium where they only pay on demand, when they have an insurable transaction. This means businesses can spread the cost over a period.

While various embodiments have been described herein, it is to be understood that the aforementioned are not intended to be limiting and that other embodiments within the spirit and scope of the aforementioned are contemplated.

It should be appreciated by the person skilled in the art that the above invention is not limited to the embodiment described. In particular, modifications and improvements may be made without departing from the scope of the present invention.

It should be further appreciated by the person skilled in the art that one or more of the above modifications or improvements, not being mutually exclusive, may be further combined to form yet further embodiments of the present invention.

1. A system for facilitating trade insurance and financing comprising,
a central controller arranged in communication with one or more databases to electronically obtain information from the databases, wherein the information includes an invoice; and
a blockchain hub operationally connected to the central controller for circulating the information from the central controller to one or more platforms, the blockchain hub capable of generating a hash response output based on a request from the one or more platforms,
wherein if the invoice meets at least one pre-determined criterion, the central controller provides the invoice to an insurer for insurance and a lender for financing.

2. A system according to claim 1, wherein one of the databases is a seller device in data communication with the central controller for sellers to submit invoices to the central controller.

3. A system according to claim 1 or 2, wherein one of the databases is a buyer device in data communication with the central controller for buyers to engage with sellers who wishes to transact with them.

4. A system according to any preceding claim, wherein one of the databases is an insurer device in data communication with the central controller to receive the invoice transmitted by the central controller.

5. A system according to any preceding claim, wherein one of the databases is a verifier device in data communication with the central controller for verifying information transmitted to and from the central controller, including verifying whether the invoice meets various criteria and verifying authenticity of sales of goods.

6. A system according to any preceding claim, wherein one of the databases is a lender device in data communication with the central controller for use by lenders to view information for making a decision on whether to finance invoices.

7. A system according to any preceding claim wherein the central controller comprises one or more components selected from a group including a processor, a memory, a communications port, an input device, an output device and a storage device.

8. A system according to any preceding claim wherein each of the one or more databases contains information for identifying the database.

9. A system according to any preceding claim wherein one of more bills of lading are submitted to the central controller.

10. A system according to claim 9 wherein each bill of lading is encoded as a blockchain to be linked to one or more other bills of lading.

11. A system according to claim 10 wherein verification of whether the invoice meets the predetermined criterion is carried out by matching the one or more bills of lading with a record in an external database.

12. A system according to claim 11 wherein successful verification results in approval of the invoice.

13. A system according to claim 1 wherein the system is operable to work with one or more programmes selected from a group comprising: two factor authentication, optical character recognition, machine learning, database management, data analytics, business intelligence, artificial intelligence and application programming interface.

14. A system according to claim 1, wherein the system includes a processor for processing insurance claims automatically upon non-payment of a buyer associated with the particular invoice.

15. A system according to claim 1 wherein the blockchain hub comprises a distributed messaging system communicating with the one or more platforms for circulating the information from the central controller to the one or more platforms.

16. A method for providing trade finance, comprising the steps of
storing information in one or more databases, wherein the information includes an invoice; and
communicating the information to a central controller operationally connected to a blockchain hub generating a hash response output for circulation between one or more platforms; and
providing the invoice to a lender for financing the invoice if the invoice meets at least one pre-determined criterion.

17. A method according to claim 16 wherein information stored in the one or more databases is provided by one or more devices selected from a group comprising: a seller device, a buyer device, an insurer device, a verifier device and a lender device.

18. A method according to claim 16 or claim 17 further comprising the step of using optical character recognition for extracting information from the invoice.

19. A method according to any of claims 16 to 18, further comprising the step of verifying the authenticity of a sale of goods related to the invoice.

20. A method according to any of claims 16 to 19, further comprising the step of automatically processing an insurance claim upon non-payment of the invoice.

21. A platform for facilitating procurement of insurance for trade finance, the platform comprising:
a memory storing information about a seller and a buyer whom the seller wishes to trade with;
a processor for matching and tagging the seller to an insurer and/or to a specific lender;
wherein transactions between the seller, the buyer, the insurer and the lender are recorded on a blockchain and/or distributed ledger.

22. A platform according to claim 21 wherein the processer carries out the matching and tagging based on one or more pieces of information selected from a group comprising of location, industry, volume of turnover, average invoice value, pricing, payment terms.
